(19) United States
(12) Patent Application Publication
(10) Pub. No.: US 2025/0290808 A1
(43) Pub. Date: Sep. 18, 2025

(54) DETECTION DEVICE

(71) Applicant: Japan Display Inc., Tokyo (JP)

(72) Inventors: Hitoshi TANAKA, Tokyo (JP); Yosuke HYODO, Tokyo (JP); Kazunori YAMAGUCHI, Tokyo (JP); Junji KOBASHI, Tokyo (JP)

(21) Appl. No.: 19/077,247

(22) Filed: Mar. 12, 2025

(30) Foreign Application Priority Data
Mar. 14, 2024 (JP) 2024-040071

(51) Int. Cl. G01L 1/20

(52) U.S. Cl. CPC G01L 1/205

(57) ABSTRACT

A detection device includes: a first substrate having a first surface; and a sensor layer facing the first surface. The first substrate is provided with: a detection electrode on the first surface; a common electrode on the first surface and around the detection electrode; a transistor, a gate line, a signal line, and a reference potential line covered by an organic insulating layer; a first contact hole formed on the first surface and coupling the source electrode or the drain electrode of the transistor to the detection electrode; a second contact hole formed on the first surface and coupling the reference potential line to the common electrode; and a spacer provided between the first surface and the common electrode and making part of the common electrode protrude toward the sensor layer with respect to the detection electrode. The sensor layer is supported by the common electrode with a gap therebetween.

### CROSS-REFERENCE TO RELATED APPLICATION

This application claims the benefit of priority from Japanese Patent Application No. 2024-040071 filed on Mar. 14, 2024, the entire contents of which are incorporated herein by reference.

### BACKGROUND

### 1. Technical Field

What is disclosed herein relates to a detection device.

### 2. Description of the Related Art

A detection device herein is a device that detects force. The detection device includes a common electrode, detection electrodes, and a sensor layer in contact with the common electrode and the detection electrodes. As described in Japanese Patent Application Laid-open Publication No. 2018-146489, the sensor layer includes a body made of rubber, for example, and a plurality of conductive particles dispersed in the body. When force is applied to the sensor layer, the body deforms, and the conductive particles come into contact with each other. As a result, the resistance of the sensor layer decreases, and a current flows from the common electrode to the detection electrodes via the sensor layer.

When the application of force is released, the body of the sensor layer returns to its original shape. However, it takes time for the body to return to its original shape. In other words, some of the conductive particles remain in contact with each other until the body returns to its original shape, and the resistance of the sensor layer does not increase quickly. As a result, a current flows to the detection electrodes via the sensor layer immediately after the application of force is released. For this reason, it is desired that the detection electrodes quickly detect that no force is applied when the application of force is released.

### SUMMARY

According to an aspect, a detection device includes: a first substrate having a first surface formed of an organic insulating layer; and a sensor layer facing the first surface. The first substrate is provided with: a detection electrode provided on the first surface; a common electrode provided on the first surface and disposed around the detection electrode; a transistor covered by the organic insulating layer; a gate line covered by the organic insulating layer and coupled to a gate electrode of the transistor; a signal line covered by the organic insulating layer and coupled to one of a source electrode and a drain electrode of the transistor; a reference potential line covered by the organic insulating layer; a first contact hole formed on the first surface and coupling the other of the source electrode and the drain electrode of the transistor to the detection electrode; a second contact hole formed on the first surface and coupling the reference potential line to the common electrode; and a spacer that is provided between the first surface and the common electrode and makes part of the common electrode protrude toward the sensor layer with respect to the detection electrode. The sensor layer is supported by the common electrode with a gap between the sensor layer and the detection electrode.

According to an aspect, a detection device includes: a first substrate having a first surface formed of an organic insulating layer; and a sensor layer facing the first surface. The first substrate is provided with: a detection electrode provided on the first surface; a common electrode disposed around the detection electrode on the first surface; a signal line covered by the organic insulating layer; a reference potential line covered by the organic insulating layer; a first contact hole formed on the first surface and coupling the signal line to the detection electrode; a second contact hole formed on the first surface and coupling the reference potential line to the common electrode; and a spacer provided between the first surface and the common electrode and that makes part of the common electrode protrude toward the sensor layer with respect to the detection electrode. The sensor layer is supported by the common electrode with a gap between the sensor layer and the detection electrode.

### BRIEF DESCRIPTION OF THE DRAWINGS

FIG. 1 is a schematic front view of a detection device according to a first embodiment;

FIG. 2 is a schematic of a section of the detection device according to the first embodiment, and more specifically a schematic sectional view along line II-II of FIG. 3;

FIG. 3 is an enlarged view of part (a plurality of individual detection regions) of a first surface of a first substrate according to the first embodiment viewed from a sensor layer;

FIG. 4 is a circuit diagram of a circuit configuration of the detection device according to the first embodiment;

FIG. 5 is an enlarged view of a state where conductive tapes are applied onto the first surface of the first substrate according to the first embodiment viewed from the sensor layer;

FIG. 6 is a sectional view schematically illustrating a state where force is applied to the detection device according to the first embodiment;

FIG. 7 is a sectional view schematically illustrating a state immediately after the force applied to the detection device according to the first embodiment is released;

FIG. 8 is an enlarged view of part of the first surface of the first substrate according to a first modification viewed from the sensor layer;

FIG. 9 is an enlarged view of a state where the conductive tape is bonded to the first substrate according to the first modification viewed from the sensor layer;

FIG. 10 is a schematic of a section of the detection device according to a second modification;

FIG. 11 is a schematic front view of the detection device according to the second modification;

FIG. 12 is a schematic of a section of the detection device according to a third modification;

FIG. 13 is a schematic of a section of the detection device according to a second embodiment, and more specifically a schematic sectional view along line XIII-XIII of FIG. 14;

FIG. 14 is a view of part (a plurality of individual detection regions) of the first surface of the detection device according to the second embodiment viewed from the sensor layer;

FIG. 15 is a circuit diagram of a circuit configuration of the detection device according to the second embodiment;

FIG. 16 is a schematic front view of the detection device according to the second embodiment;

FIG. 17 is a view of a state where the conductive tapes are disposed on the first surface of the detection device according to the second embodiment viewed from the sensor layer; and

FIG. 18 is a schematic of a section along line XVIII-XVIII of FIG. 14.

### DETAILED DESCRIPTION

Exemplary aspects (embodiments) to embody a detection device according to the present disclosure are described below in greater detail with reference to the accompanying drawings. The contents described in the embodiments are not intended to limit the present disclosure. Components described below include components easily conceivable by those skilled in the art and components substantially identical therewith. Furthermore, the components described below may be appropriately combined. What is disclosed herein is given by way of example only, and appropriate modifications made without departing from the spirit of the present disclosure and easily conceivable by those skilled in the art naturally fall within the scope of the present disclosure. To simplify the explanation, the drawings may possibly illustrate the width, the thickness, the shape, and other elements of each unit more schematically than those in the actual aspect. These elements, however, are given by way of example only and are not intended to limit interpretation of the present disclosure. In the present specification and the drawings, components similar to those previously described with reference to previous drawings are denoted by the same reference numerals, and detailed explanation thereof may be appropriately omitted.

To describe an aspect regarding a certain structure on or above which another structure is disposed in the present specification and the claims, when “on” is simply used, it indicates both the following cases unless otherwise noted: a case where the other structure is disposed directly on and in contact with the certain structure, and a case where the other structure is disposed above the certain structure with yet another structure interposed therebetween.

### First Embodiment

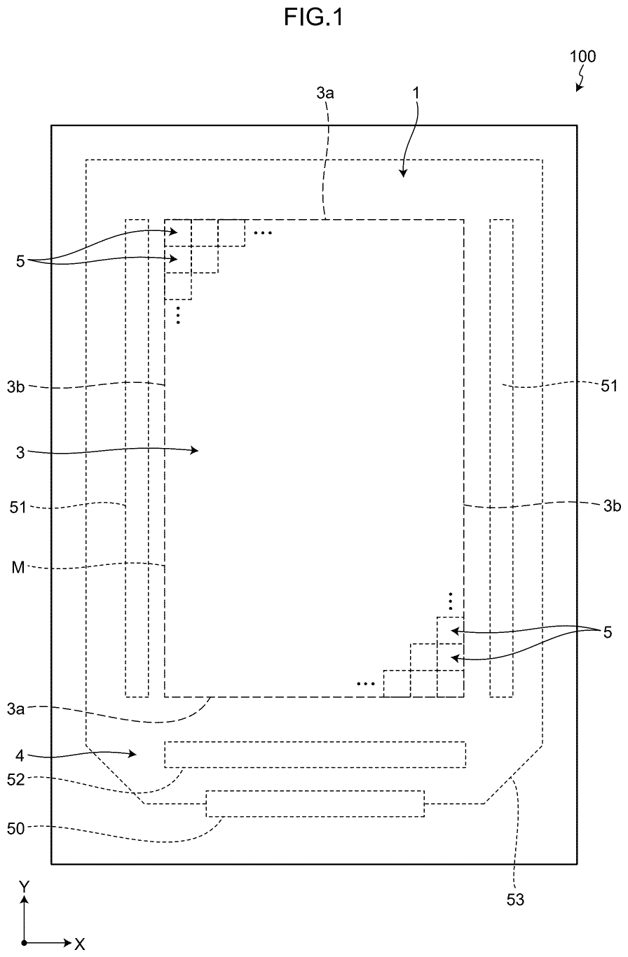

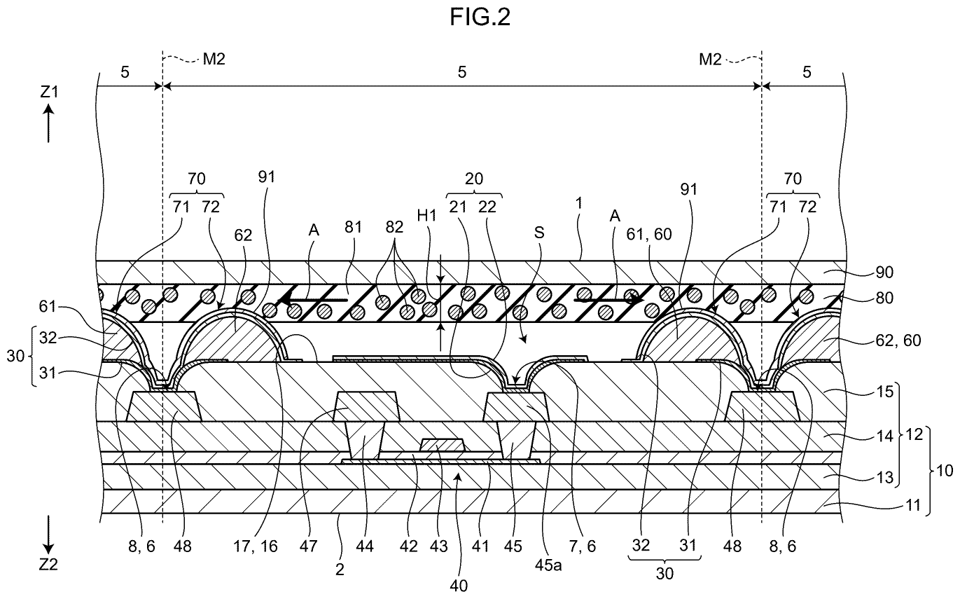

FIG. 1 is a schematic front view of a detection device according to a first embodiment. A detection device 100 is a device that detects force acting on a detection surface 1. As illustrated in FIG. 1, the detection device 100 is formed in a flat plate shape. The detection device 100 has a flat front surface (detection surface 1) and a flat back surface 2 (not illustrated in FIG. 1, and refer to FIG. 2). The detection device 100 has a rectangular shape when viewed in the direction normal to the detection surface 1.

The detection surface 1 is divided into a detection region 3 in which force can be detected and a peripheral region 4 in which force cannot be detected. The detection region 3 is positioned at the center of the detection surface 1. The peripheral region 4 is formed in a frame shape and surrounds the outer periphery of the detection region 3.

The detection region 3 has a rectangular shape when viewed in the direction normal to the detection surface 1. Therefore, an outer frame M of the detection region 3 has a pair of short sides 3a and a pair of long sides 3b. In the following description, the direction parallel to the detection surface 1 and parallel to the short side 3a is referred to as a first direction X. The direction parallel to the detection surface 1 and parallel to the long side 3b is referred to as a second direction Y. Thus, the second direction Y is a direction orthogonal to (intersecting) the first direction X. The direction parallel to the detection surface 1 may be referred to as a planar direction.

The detection region 3 is divided into a plurality of individual detection regions 5. In other words, the detection region 3 is composed of the individual detection regions 5. Force is detected in each of the individual detection regions 5. When viewed in the direction normal to the detection surface 1, the individual detection region 5 has a square shape. The individual detection regions 5 are arrayed in the first direction X and the second direction Y.

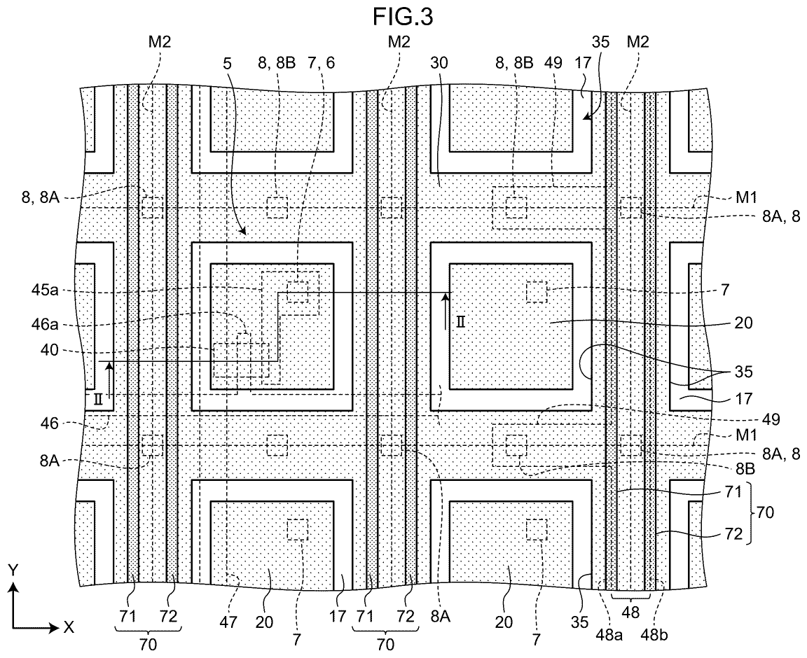

FIG. 2 is a schematic of a section of the detection device according to the first embodiment, and more specifically a schematic sectional view along line II-II of FIG. 3. As illustrated in FIG. 2, the detection device 100 includes a first substrate 10, a sensor layer 80, and a protective layer 90 stacked in this order. In the following description, the direction in which the first substrate 10, the sensor layer 80, and the protective layer 90 are stacked is referred to as a stacking direction. The direction normal to the detection surface 1 described above is the same meaning as the stacking direction. A direction from the first substrate 10 toward the sensor layer 80 along the stacking direction is referred to as a first stacking direction Z1, and a direction opposite thereto is referred to as a second stacking direction Z2. Viewing in the first stacking direction Z1 is referred to as plan view.

The first substrate 10 has a base 11 and a circuit formation layer 12 that is formed on a side of the base 11 in the first stacking direction Z1. The base 11 is a plate-like member that supports the circuit formation layer 12 and has an insulating property. While the base 11 is a flexible substrate made of polyimide, for example, the present disclosure is not limited thereto. The surface of the base 11 facing in the second stacking direction Z2 serves as the back surface 2 of the detection device 100.

The circuit formation layer 12 includes a first insulating layer 13, a second insulating layer 14, and a third insulating layer 15 stacked in this order on the surface of the base 11 facing in the first stacking direction Z1. The space between the first insulating layer 13 and the second insulating layer 14 is provided with a gate insulating film 42 of a transistor 40, which will be described later.

The first insulating layer 13 and the second insulating layer 14 are made of inorganic material, such as SiO and SiN. The third insulating layer 15 is an organic insulating layer made of organic material. The third insulating layer 15 is a layer (planarization film) for planarizing the surface of the circuit formation layer 12 facing in the first stacking direction Z1. Therefore, a first surface 16 of the circuit formation layer 12 facing in the first stacking direction Z1 is composed of the third insulating layer 15. The first surface 16 of the circuit formation layer 12 is provided with detection electrodes 20, a common electrode 30, and spacers 60 and has contact holes 6.

The detection electrode 20 and the common electrode 30 are metal films (metal layers) made of metal material, such as indium tin oxide (ITO), and formed on the first surface 16. The detection electrode 20 and the common electrode 30 according to the present embodiment each have a two-layered structure. In other words, the detection electrode 20 includes a first detection electrode layer 21 formed on the first surface 16 and a second detection electrode layer 22 formed on the first detection electrode layer 21. The common electrode 30 includes a first common electrode layer 31 formed on the first surface 16 and a second common electrode layer 32 formed on a side of the first common electrode layer 31 facing in the first stacking direction Z1.

FIG. 3 is an enlarged view of part (a plurality of individual detection regions) of the first surface of the first substrate according to the first embodiment viewed from the sensor layer. In FIG. 3, the detection electrode 20 and the common electrode 30 are shaded with dots to make them easier to see. As illustrated in FIG. 3, the detection electrode 20 is disposed at the center of the individual detection region 5. The detection electrode 20 has a square shape in plan view. A plurality of detection electrodes 20 are formed on the first surface 16. In other words, each individual detection region 5 is provided with one detection electrode 20.

The common electrode 30 is a solid film formed on the first surface 16 and extends across a plurality of individual detection regions 5. The common electrode 30 has a plurality of openings 35 having a square shape in plan view. Each individual detection region 5 has one opening 35. The detection electrode 20 is disposed in the opening 35. Therefore, the detection electrode 20 is surrounded by the common electrode 30.

The opening 35 is larger than the detection electrode 20. Therefore, part of the first surface 16 between the edge of the opening 35 of the common electrode 30 and the edge of the detection electrode 20 is exposed. In other words, the detection electrode 20 and the common electrode 30 are separated from each other and are not electrically coupled on the first surface 16. The part of the first surface 16 exposed through the opening 35 may be hereinafter referred to as a first surface exposed portion 17. The first surface exposed portion 17 has an annular shape (square frame shape).

As illustrated in FIG. 2, the spacer 60 has an insulating property and is made of the same organic material as the third insulating layer 15. The spacer according to the present disclosure simply needs to have an insulating property and is not necessarily made of organic material. The spacer 60 is stacked across the first surface 16 and the first common electrode layer 31. The second common electrode layer 32 is formed on a side of the spacer 60 in the first stacking direction Z1. Therefore, part of the second common electrode layer 32 protrudes in the first stacking direction Z1. The part of the second common electrode layer 32 protrudes in the first stacking direction Z1 with respect to the second detection electrode layer 22 (detection electrode 20). The part of the second common electrode layer 32 stacked on the spacer 60 and protruding with respect to the second detection electrode layer 22 (detection electrode 20) is hereinafter referred to as a protrusion 70.

The spacer 60 includes a pair of a first spacer 61 and a second spacer 62 spaced apart from each other in the first direction X. Therefore, the protrusion 70 includes a first protrusion 71 stacked on the first spacer 61 and a second protrusion 72 stacked on the second spacer 62. The first spacer 61 and the second spacer 62 extend in the second direction Y. Therefore, the first protrusion 71 and the second protrusion 72 also extend in the second direction Y as illustrated in FIG. 3. In FIG. 3, the shading indicating the part of the common electrode 30 provided with the protrusion 70 is different from that indicating the part other than the protrusion 70.

The boundary line that divides the individual detection regions 5 in the second direction Y is hereinafter referred to as a first boundary line M1. The boundary line that divides the individual detection regions 5 in the first direction X is referred to as a second boundary line M2. As illustrated in FIG. 2, a plurality of the spacers 60 are provided. The spacers 60 are arrayed in the first direction X. The second boundary line M2 is arranged between a pair of the first spacer 61 and the second spacer 62. Therefore, the second boundary line M2 is arranged between a pair of the first protrusion 71 and the second protrusion 72.

Thus, the first protrusion 71 is disposed along the second boundary line M2 on one end side in the first direction X in the individual detection region 5 as illustrated in FIG. 3. The second protrusion 72 is disposed along the second boundary line M2 on the other end side in the first direction X in the individual detection region 5.

As illustrated in FIG. 2, the contact hole 6 is a hole extending in the second stacking direction Z2 from the first surface 16 of the first substrate 10. A plurality of contact holes 6 are formed. Each contact hole 6 is formed in a part of the first surface 16 covered by either the detection electrode 20 or the common electrode 30. With this configuration, the detection electrode 20 and the common electrode 30 can be coupled to electrical wiring in the circuit formation layer 12. The hole covered by the detection electrode 20 out of the contact holes 6 is hereinafter referred to as a first contact hole 7, and the hole covered by the common electrode 30 is referred to as a second contact hole 8.

As illustrated in FIG. 3, the first contact hole 7 is formed near the center of the individual detection region 5. The second contact holes 8 include corner second contact holes 8A and first boundary-line second contact holes 8B. The corner second contact holes 8A are formed at the four corners of the individual detection region 5. The first boundary-line second contact hole 8B is formed in the second direction Y with respect to the first contact hole 7 and overlaps the first boundary line M1.

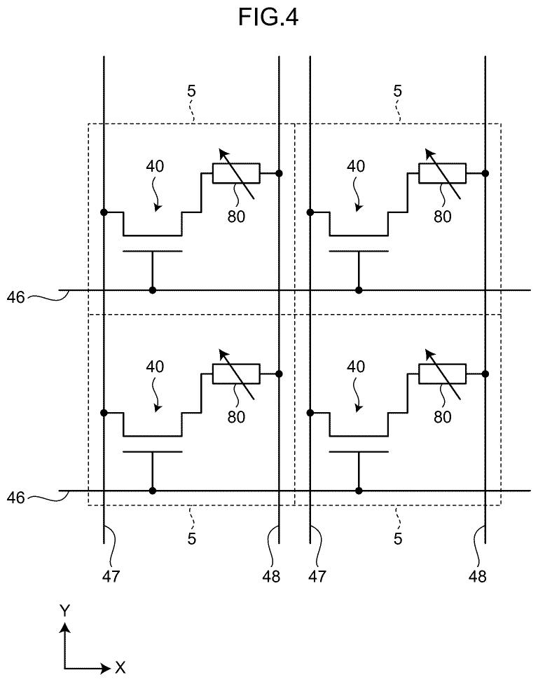

FIG. 4 is a circuit diagram of a circuit configuration of the detection device according to the first embodiment. As illustrated in FIG. 4, the circuit formation layer 12 is provided with a transistor 40, a gate line 46, a signal line 47, a reference potential line 48, a coupling section 50 (refer to FIG. 1), a gate line drive circuit 51 (refer to FIG. 1), a signal line selection circuit 52 (refer to FIG. 1), and a common line 53 (refer to FIG. 1). A plurality of the transistors 40, a plurality of the gate lines 46, a plurality of the signal lines 47, and a plurality of the reference potential lines 48 are formed.

The transistor 40 is a switching element. The transistors 40 are provided to the respective individual detection regions 5. As illustrated in FIG. 2, the transistor 40 includes a semiconductor layer 41, the gate insulating film 42, a gate electrode 43, a drain electrode 44, and a source electrode 45. The end of the source electrode 45 in the first stacking direction Z1 is coupled to coupling line 45a. The coupling line 45a extends in the planar direction (refer to FIG. 3) and is coupled to the detection electrode 20 (first detection electrode layer 21). To make the drawing easier to see, FIG. 3 illustrates only one of the transistors 40.

Each gate line 46 extends in the first direction X. The gate lines 46 are arrayed in the second direction Y. As illustrated in FIG. 3, the gate line 46 is provided with a branch 46a extending in the second direction Y. The branch 46a is provided to each individual detection region 5. The gate line 46 is coupled to the gate electrodes 43 (refer to FIG. 2) of the respective transistors 40 arrayed in the first direction X via the branches 46a. To make the drawing easier to see, FIG. 3 illustrates only one of the gate lines 46.

As illustrated in FIG. 4, each signal line 47 extends in the second direction Y. The signal lines 47 are arrayed in the first direction X. The signal line 47 is coupled to the drain electrodes 44 (refer to FIG. 2) of the respective transistors 40 arrayed in the second direction Y. To make the drawing easier to see, FIG. 3 illustrates only one of the signal lines 47.

As illustrated in FIG. 4, each of the reference potential lines 48 extends in the second direction Y. The reference potential lines 48 are arrayed in the first direction X. As illustrated in FIG. 3, each reference potential line 48 overlaps the second boundary line M2 in plan view. Therefore, the reference potential line 48 overlaps the corner second contact holes 8A. The reference potential line 48 and the common electrode 30 (first common electrode layer 31) are coupled through the corner second contact hole 8A. To make the drawing easier to see, FIG. 3 illustrates only one of the reference potential lines 48.

As illustrated in FIG. 3, the first spacer 61 (first protrusion 71) overlaps a first end 48a of the reference potential line 48 in the first direction X in plan view, and the second spacer 62 (second protrusion 72) overlaps a second end 48b of the reference potential line 48 in the first direction X.

As illustrated in FIG. 3, the reference potential line 48 is provided with reference potential branch lines 49 branching off in the first direction X. The reference potential branch line 49 overlaps the first boundary line M1 in plan view. In other words, the reference potential branch line 49 overlaps the first boundary-line second contact hole 8B. With this configuration, the reference potential line 48 and the common electrode 30 (first common electrode layer 31) are coupled through the first boundary-line second contact hole 8B.

As illustrated in FIG. 1, the coupling section 50, the gate line drive circuit 51, the signal line selection circuit 52, and the common line 53 are provided in the peripheral region 4 of the circuit formation layer 12. The coupling section 50 couples the detection device 100 to a drive integrated circuit (IC) disposed outside the detection device 100. The drive IC may be mounted as a chip on film (COF) on a flexible printed circuit board or a rigid circuit board coupled to the coupling section 50. Alternatively, the drive IC may be mounted as a chip on glass (COG) in the peripheral region 4 of the first substrate 10.

The gate line drive circuits 51 are circuits that drive the gate lines 46 (refer to FIG. 4) based on various control signals from the drive IC. The gate line drive circuits 51 sequentially or simultaneously select a plurality of gate lines 46 and supply gate drive signals to the selected gate lines 46.

The signal line selection circuit 52 is a switch circuit that sequentially or simultaneously selects the signal lines 47 (refer to FIG. 4). The signal line selection circuit 52 is a multiplexer, for example. The signal line selection circuit 52 couples the selected signal lines 47 to the drive IC based on selection signal supplied from the drive IC.

The common line 53 is coupled to the drive IC via the coupling section 50 and is supplied with a certain amount of current from the drive IC. The common line 53 extends along the peripheral region 4 and has an annular (frame-like) shape. The common line 53 is coupled to the reference potential lines 48. Therefore, the common electrode 30 is supplied with a certain amount of current.

As illustrated in FIG. 2, a plurality of conductive tapes 91 are provided on a side of the first substrate 10 facing in the first stacking direction Z1. The conductive tape 91 includes a conductive body layer and adhesive layers provided on both surfaces of the body layer, which are not specifically illustrated.

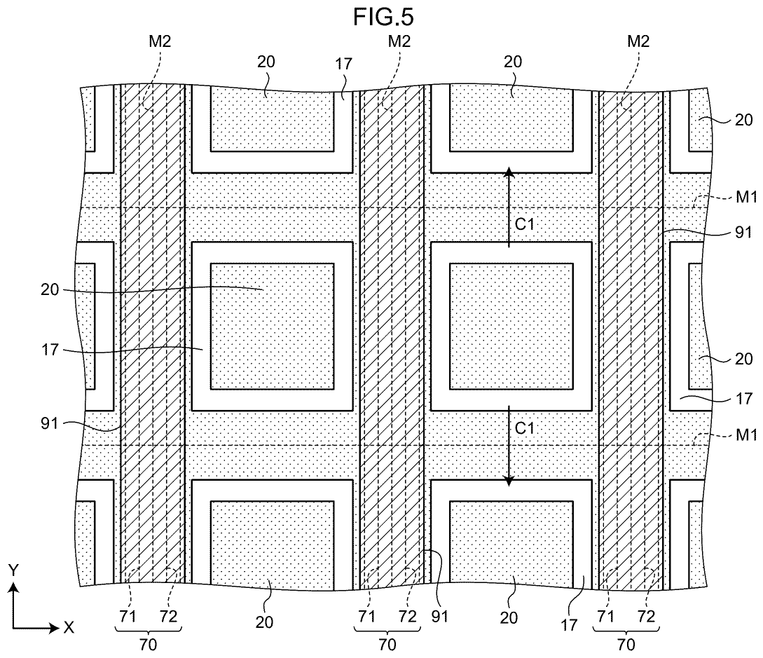

FIG. 5 is an enlarged view of a state where the conductive tapes are applied onto the first surface of the first substrate according to the first embodiment viewed from the sensor layer. In FIG. 5, the conductive tapes 91 are hatched with diagonal lines to make the area of the conductive tapes 91 easier to recognize. As illustrated in FIG. 5, each conductive tape 91 extends in the second direction Y. The conductive tapes 91 are arrayed in the first direction X. Each conductive tape 91 overlaps the second boundary line M2 in plan view. Thus, each conductive tape 91 is stacked on the common electrode 30 (protrusion 70). The adhesive layer (not illustrated) of each conductive tape 91 facing in the second stacking direction Z2 is bonded to the common electrode 30 (protrusion 70).

As illustrated in FIG. 2, the sensor layer 80 includes a body 81 and conductive microparticles (hereinafter referred to as conductive particles 82) dispersed in the body 81. The body 81 is made of deformable and highly insulating material, such as silicone rubber. The conductive particles 82 are separated from each other in the body 81. The thickness of the sensor layer 80 with no force applied thereto is H1. When no force is applied to the sensor layer 80, and the body 81 is not deformed, the resistance of the sensor layer 80 is high. By contrast, when force is applied to the sensor layer 80, and the thickness of the body 81 decreases, the conductive particles 82 come into contact with or into proximity to each other, and the resistance of the sensor layer 80 decreases. The size of the sensor layer 80 is large enough to cover at least the entire detection region 3.

The sensor layer 80 is supported by the protrusions 70 (the first protrusion 71 and the second protrusion 72) of the first substrate 10. In other words, the sensor layer 80 is separated from the detection electrode 20 in the first stacking direction Z1. Therefore, a gap (space) S is formed between the sensor layer 80 and the detection electrode 20. The gap S according to the present embodiment is filled with air. Thus, the gap S according to the present embodiment is an air gap. The sensor layer 80 is bonded to the conductive tapes 91 and integrated with the first substrate 10. Therefore, the sensor layer 80 is supported by the protrusions 70 with tension (refer to arrows A in FIG. 2) acting in the first direction X in each individual detection region 5.

The protective layer 90 is made of elastically deformable insulating material, such as rubber and resin. The surface of the protective layer 90 in the first stacking direction Z1 serves as the detection surface 1. The sensor layer 80 is bonded to the surface of the protective layer 90 facing in the second stacking direction Z2. The sensor layer 80 and the protective layer 90 integrally formed are bonded to the first substrate 10 with a frame portion (not illustrated) interposed therebetween in the area overlapping the peripheral region 4.

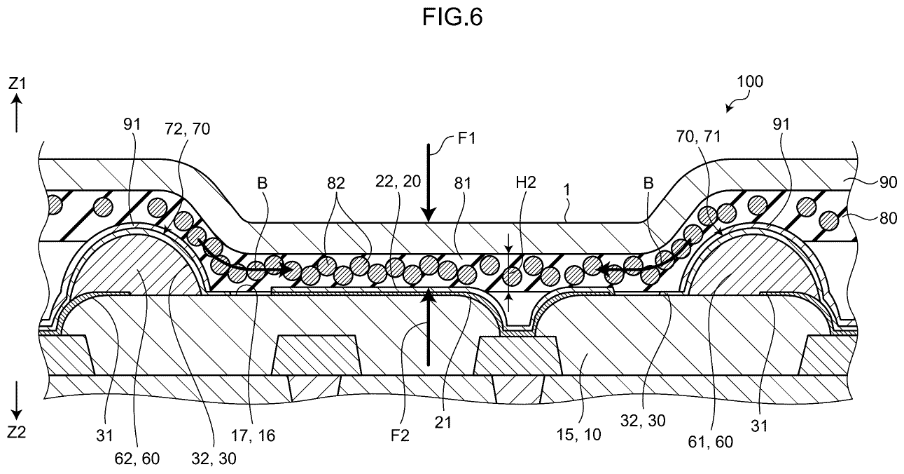

FIG. 6 is a sectional view schematically illustrating a state where force is applied to the detection device according to the first embodiment. Next, an example of the operations of the detection device 100 is described. As illustrated in FIG. 6, when force F1 is applied to the detection surface 1, the gap S is narrowed and then closed, and the protective layer 90 and the sensor layer 80 in the individual detection region 5 to which the force F1 is applied, deform in the second stacking direction Z2. As a result, the sensor layer 80 comes into contact with the detection electrode 20. In other words, the sensor layer 80 is brought into contact with both the detection electrode 20 and the common electrode 30 (protrusion 70).

At this time, the sensor layer 80 that deforms in the second stacking direction Z2 is subjected to reaction force F2 from the detection electrode 20 and the common electrode 30 (protrusion 70). In other words, a compressive load due to the force F1 and the reaction force F2 acts on the sensor layer 80. As a result, the thickness of the body 81 of the sensor layer 80 in the stacking direction decreases to H2 (H2<H1). In other words, a large number of conductive particles 82 come into contact with or into proximity to each other, and the resistance of the sensor layer 80 decreases. As a result, a current flows from the common electrode 30 to the detection electrode 20 via the sensor layer 80 (refer to arrows B in FIG. 6).

As the force F1 increases, the compression load acting on the body 81 increases. As a result, the number of conductive particles 82 in contact with or in proximity to each other increases, and the resistance of the sensor layer 80 is further reduced. Therefore, the amount of current flowing to the detection electrode 20 increases. Thus, the current value input to the detection electrode 20 increases in proportion to the applied force F1. The electrical signal (current value) input to the detection electrode 20 is output by the signal line 47 to the drive IC. Based on the magnitude of the current value, the drive IC derives the load input to the individual detection region 5. The current value input to the detection electrode 20 according to the present embodiment is proportional to the magnitude of the applied force. For example, the current value input to the detection electrode 20 may increase as the applied force increases, and the present disclosure is not limited to the example described in the embodiment.

As illustrated in FIG. 5, the air filled in the gap S in one individual detection region 5 moves to the gaps S in other individual detection regions 5 adjacent to the one individual detection region 5 in the second direction Y (refer to arrows C1). This prevents the sensor layer 80 from failing to come into contact with the detection electrode 20 due to high air pressure in the gap S.

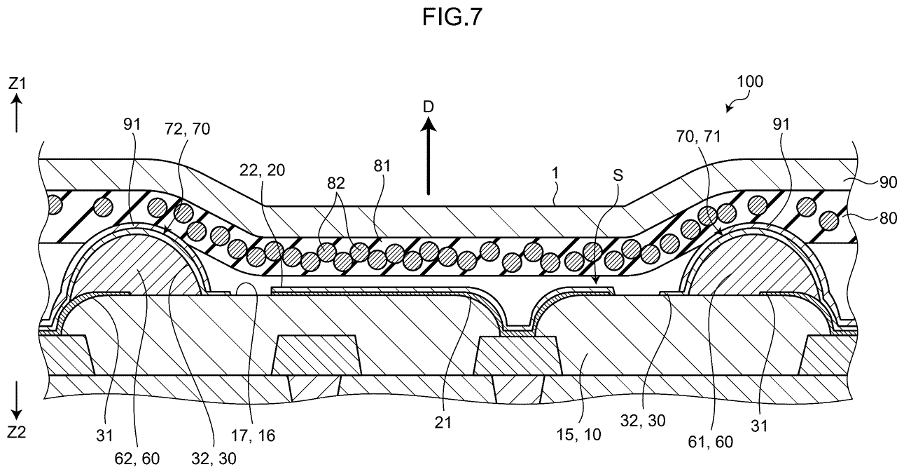

FIG. 7 is a sectional view schematically illustrating a state immediately after the force applied to the detection device according to the first embodiment is released. As illustrated in FIG. 7, when the application of the force F1 is released, the sensor layer 80 and the protective layer 90 return to their original shapes. In other words, the part of the sensor layer 80 that deforms in the second stacking direction Z2 moves in the first stacking direction Z1 (refer to arrow D in FIG. 7), and the thickness of the body 81 in the stacking direction returns to its original thickness.

It takes time for the thickness of the body 81 to return to its original thickness H1. This is because it takes time for the stress acting on the body 81 to be eliminated. Therefore, immediately after the application of the force F1 is released, a large number of conductive particles 82 are still in contact with or in proximity to each other, and the resistance of the sensor layer 80 has not returned to its original value (high resistance) yet. As a result, if the sensor layer 80 is in contact with both the detection electrode 20 and the common electrode 30 immediately after the application of the force F1 is released, a current flows to the detection electrode 20 via the sensor layer 80, and the force F1 is detected.

By contrast, when the application of the force F1 is released, the sensor layer 80 according to the present embodiment moves in the first stacking direction Z1. In other words, when the application of the force F1 is released, the sensor layer 80 breaks the electrical coupling between the detection electrode 20 and the common electrode 30. Therefore, no current flows to the detection electrode 20, and the force F1 is not detected.

As described above, the detection device 100 according to the present embodiment breaks the electrical coupling (contact of the sensor layer 80) between the detection electrode 20 and the common electrode 30 before the resistance of the sensor layer 80 returns to its original value. Therefore, the detection electrode 20 detects more quickly (earlier) that no force is applied than a detection device in which the gap S is not formed (detection device in which the sensor layer is always in contact with both the common electrode and the detection electrode).

The sensor layer 80 is bonded to the protrusions 70 by the conductive tapes 91 at opposite ends in the first direction X of each individual detection region 5 and is subjected to tension (refer to arrows A in FIG. 2). With this configuration, the restoring force (force to return to the original shape) acting on the body 81 is large, and the sensor layer 80 quickly moves away from the detection electrode 20. Therefore, the detection electrode 20 detects more quickly (earlier) that no force is applied.

Next, modifications are described in which the detection device 100 according to the first embodiment is partially modified. The following describes the modifications focusing on the differences from the detection device described above.

### First Modification

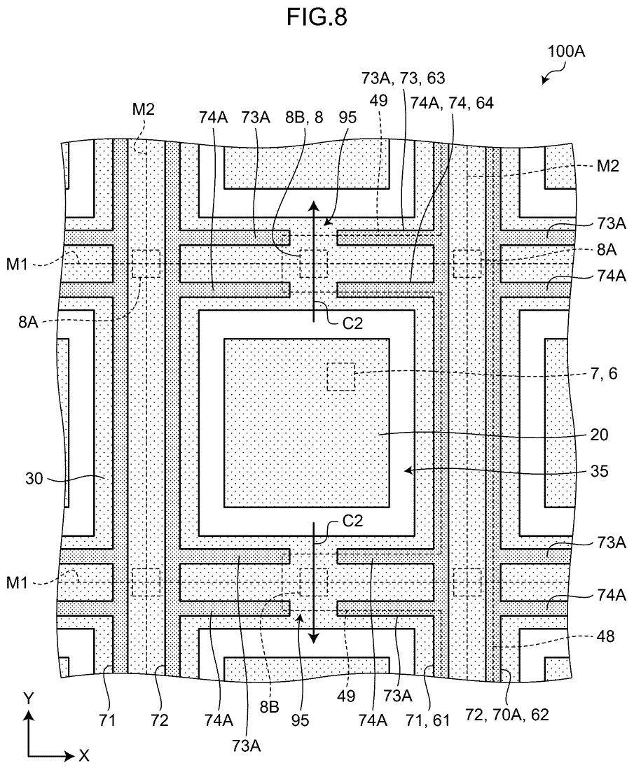

FIG. 8 is an enlarged view of part of the first surface of the first substrate according to a first modification viewed from the sensor layer. As illustrated in FIG. 8, a protrusion 70A of a detection device 100A according to the first modification is different from the first embodiment in that the protrusion includes a plurality of pairs of a third protrusion 73 and a fourth protrusion 74. In other words, the first surface 16 according to the first modification is provided with third spacers 63 for forming the third protrusions 73 and fourth spacers 64 for forming the fourth protrusions 74.

A pair of the third protrusion 73 and the fourth protrusion 74 are spaced apart from each other in the second direction Y. The first boundary line M1 is positioned between a pair of the third protrusion 73 and the fourth protrusion 74. A pair of the third protrusion 73 and the fourth protrusion 74 is disposed between the first protrusion 71 and the second protrusion 72 disposed with the detection electrode 20 sandwiched therebetween.

The third protrusion 73 and the fourth protrusion 74 each extend intermittently in the first direction X. In other words, the third protrusion 73 is composed of two (a plurality of) partial protrusions 73A. The fourth protrusion 74 is composed of two (a plurality of) partial protrusions 74A.

One of the two partial protrusions 73A is coupled to the first protrusion 71. The other of the two partial protrusions 73A is coupled to the second protrusion 72 of the other pair. Similarly, one of the two partial protrusions 74A is coupled to the first protrusion 71. The other of the two partial protrusions 74A is coupled to the second protrusion 72 of the other pair.

Therefore, a communication hole 95 according to the first modification is formed between the partial protrusions 73A and between the partial protrusions 74A. The communication hole 95 allows the gaps S in the individual detection regions 5 adjacent to each other in the second direction Y to communicate. While the partial protrusions 73A and 74A according to the present embodiment are coupled to the first protrusion 71 and the second protrusion 72, the partial protrusions 73A and 74A according to the present disclosure are not necessarily coupled to them. With this configuration, the number of communication holes 95 increases.

One of the two partial protrusions 73A overlaps one end of the reference potential branch line 49 in the second direction Y. One of the two partial protrusions 74A overlaps the other end of the reference potential branch line 49 in the second direction Y. In other words, at least part of the third protrusion 73 overlaps one end of the reference potential branch line 49 in the second direction Y. At least part of the fourth protrusion 74 overlaps the other end of the reference potential branch line 49 in the second direction Y.

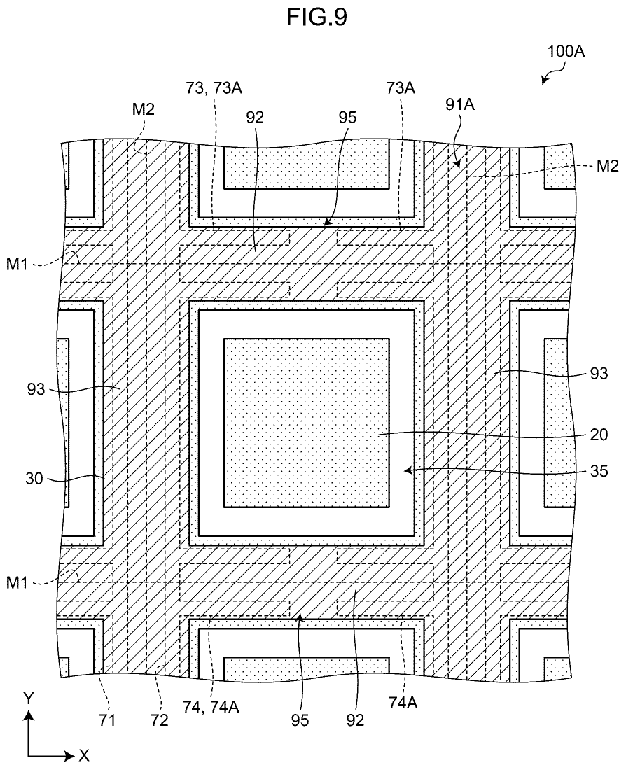

FIG. 9 is an enlarged view of a state where the conductive tape is bonded to the first substrate according to the first modification viewed from the sensor layer. As illustrated in FIG. 9, a conductive tape 91A according to the first modification is different from the conductive tape 91 according to the first embodiment in that the conductive tape has a plurality of horizontal portions 92 extending along the first boundary line M1 and a plurality of vertical portions 93 extending along the second boundary line M2 and has a grid shape.

With the conductive tape 91A, the first protrusions 71 and the second protrusions 72, and the third protrusions 73 and the fourth protrusions 74 of the first substrate 10 are bonded to the sensor layer 80. Therefore, each individual detection region 5 of the sensor layer 80 is subjected to tension in the first direction X (refer to arrows A in FIG. 2) and tension in the second direction Y. The part of the conductive tape 91A overlapping the communication hole 95 in plan view extends along the first surface 16 of the first substrate 10 (bonded to the first surface 16) and is not bonded to the sensor layer 80 so as not to close the communication hole 95.

According to the first modification described above, when force is applied, the air filled in the gap S in one individual detection region 5 to which the force is applied moves to the gaps S in other individual detection regions 5 adjacent to the one individual detection region 5 in the second direction Y through the communication holes 95 (arrows C2 in FIG. 8). This prevents the sensor layer 80 from failing to come into contact with the detection electrode 20 due to high air pressure in the gap S when force is applied.

According to the first modification, the sensor layer 80 is subjected to tension in the first direction X and tension in the second direction Y in each individual detection region 5. For this reason, when the application of the force F1 is released, the restoring force acting on the sensor layer 80 is larger than in the first embodiment. Therefore, the sensor layer 80 quickly moves away from the detection electrode 20, and the detection electrode 20 detects more quickly (earlier) that no force is applied.

### Second Modification

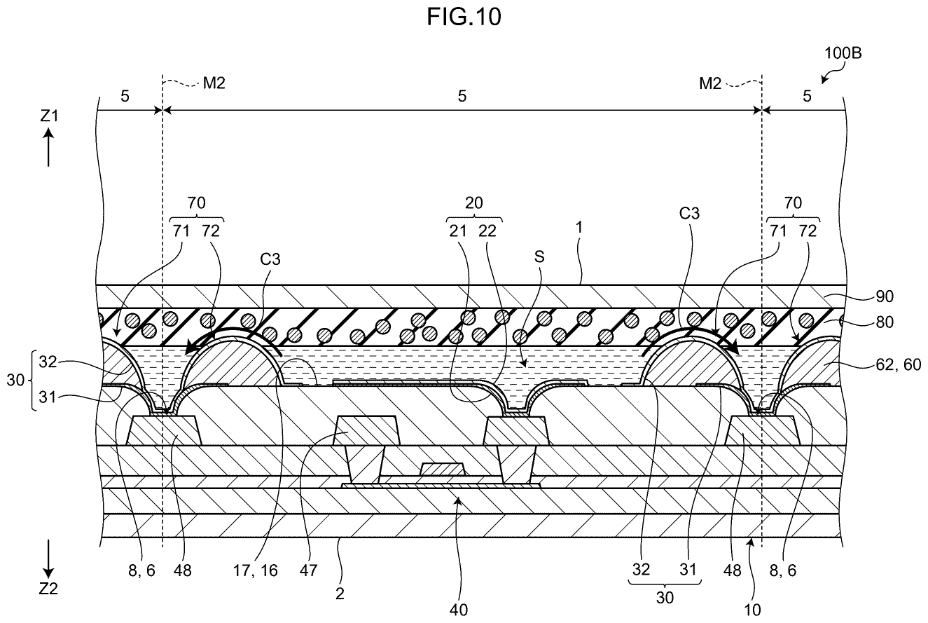

FIG. 10 is a schematic of a section of the detection device according to a second modification. As illustrated in FIG. 10, a detection device 100B according to the second modification is different from the first embodiment in that the detection device does not include the conductive tape 91. Therefore, the sensor layer 80 is not bonded to the protrusions 70. The sensor layer 80, however, is in contact with the protrusions 70, whereby the gap S is still formed between the sensor layer 80, and the first surface 16 and the detection electrode 20. The gap S in the detection device 100B according to the second modification is different from that according to the first embodiment in that the gap is filled with liquid instead of air. The liquid has an insulating property.

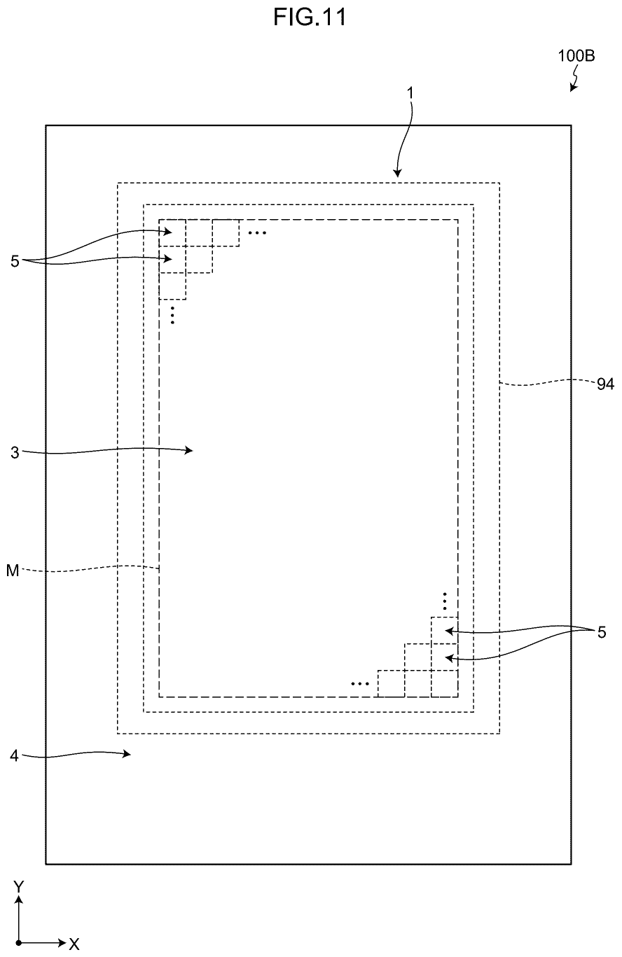

FIG. 11 is a schematic front view of the detection device according to the second modification. As illustrated in FIG. 11, the detection device 100B according to the second modification is different from the first embodiment in that a seal 94 is provided between the first surface 16 of the first substrate 10 and the sensor layer 80. The seal 94 is disposed in the peripheral region 4 and formed in a frame shape surrounding the detection region 3. The seal 94 prevents the liquid filled in the gap S from leaking to the outside.

According to the second modification, the liquid filled in the gap S in one individual detection region 5 to which force is applied moves to the gaps S in other individual detection regions 5 adjacent to the one individual detection region 5 in the second direction Y (refer to arrows C1 in FIG. 5). Alternatively, as indicated by arrows C3 in FIG. 10, the liquid passes between the protrusion 70 (the first protrusion 71 and the second protrusion 72) and the sensor layer 80 and moves to the space between the first protrusion 71 and the second protrusion 72 and/or to the gaps S in other individual detection regions 5 adjacent to the one individual detection region 5 in the first direction X. This prevents the sensor layer 80 from failing to come into contact with the detection electrode 20 due to high liquid pressure in the gap S.

Also in the second modification, when the sensor layer 80 comes into contact with the detection electrode 20, and the thickness of the sensor layer 80 decreases, a current flows from the common electrode 30 to the detection electrode 20. When the application of the force is released, the sensor layer 80 moves in the first stacking direction Z1 and releases the electrical coupling between the detection electrode 20 and the common electrode 30. When the application of the force is released, the liquid quickly enters between the sensor layer 80 and the detection electrode 20. In other words, the liquid pressed by the sensor layer 80 moves in the first direction X and the second direction Y and quickly enters between the sensor layer 80 and the detection electrode 20 due to cohesion of the liquid. As a result, the electrical coupling between the detection electrode 20 and the common electrode 30 is released earlier. Therefore, the detection electrode 20 according to the second modification can detect quickly (early) that no force is applied.

While the second modification has described an example where the gap S is filled with liquid, the present disclosure may use gas instead of liquid to fill the gap S.

### Third Modification

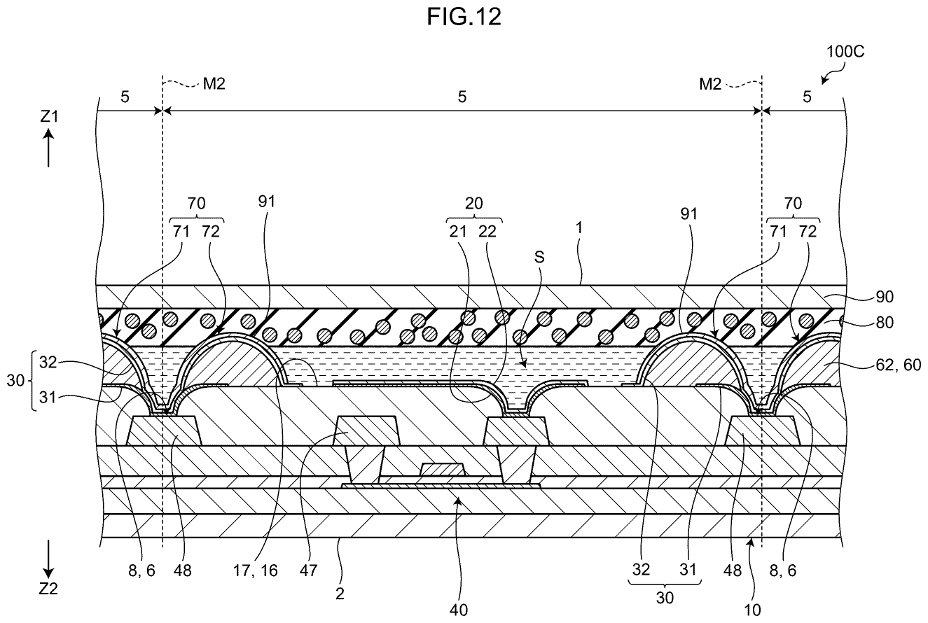

FIG. 12 is a schematic of a section of the detection device according to a third modification. As illustrated in FIG. 12, a detection device 100C according to the third modification is different from the second modification in that the detection device includes the conductive tape 91 described in the first embodiment. According to the third modification, when force is applied, the liquid does not pass between the sensor layer 80 and the protrusion 70. Therefore, the area in which the liquid can move is reduced. Meanwhile, the sensor layer 80 is subjected to tension (refer to arrows A in FIG. 2) in the first direction X in each individual detection region. Therefore, when the application of the force is released, the detection electrode 20 detects more quickly (earlier) that no force is applied than in the second modification.

While the first embodiment and the first to the third modifications have described an active matrix type detection device in which the transistors are disposed in the respective individual detection regions 5, the present disclosure may be a passive matrix type detection device. A second embodiment below describes a passive matrix type detection device.

### Second Embodiment

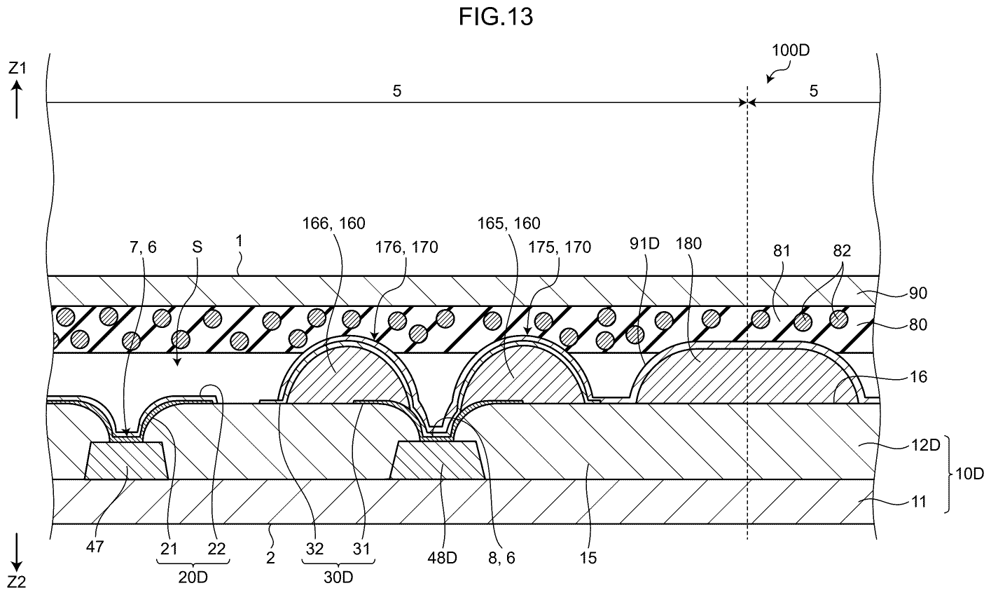

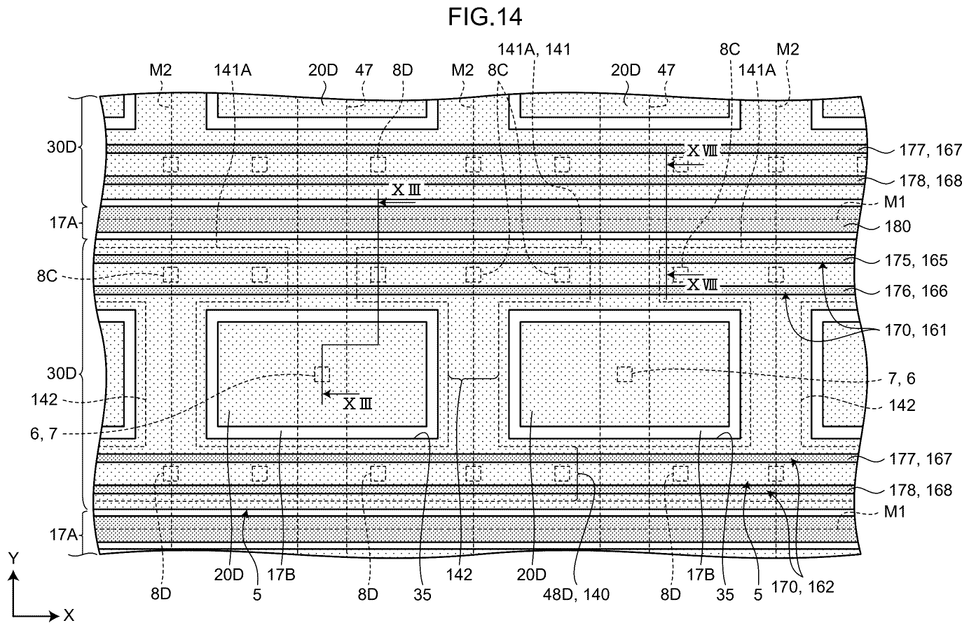

FIG. 13 is a schematic of a section of the detection device according to the second embodiment, and more specifically a schematic sectional view along line XIII-XIII of FIG. 14. A detection device 100D includes a first substrate 10D, the sensor layer 80, and the protective layer 90 stacked in this order. A conductive tape 91D is provided between the first substrate 10D and the sensor layer 80, and the first substrate 10D and the sensor layer 80 are integrated.

The first substrate 10D includes the base 11 and a circuit formation layer 12D. The circuit formation layer 12D according to the second embodiment is composed only of the third insulating layer 15 (planarization film) made of organic material. In the present disclosure, however, the configuration of the insulating layer of the circuit formation layer 12D is not particularly limited.

The first surface 16 of the first substrate 10D is provided with detection electrodes 20D, common electrodes 30D, spacers 160, the contact holes 6, and insulating banks 180. The detection electrode 20D and the common electrode 30D each have a two-layered structure as in the first embodiment.

FIG. 14 is a view of part (more than one of the individual detection regions) of the first surface of the detection device according to the second embodiment viewed from the sensor layer. The common electrode 30D according to the second embodiment extends in the first direction X across more than one of the individual detection regions 5. In the second embodiment, a plurality of the common electrodes 30D are provided. The common electrodes 30D are arrayed in the second direction Y. In other words, different common electrodes 30D are disposed for different groups each of which includes the individual detection regions 5, wherein the groups are arrayed in the second direction Y.

The common electrodes 30D adjacent in the second direction Y are separated from each other and are not electrically coupled on the first surface 16. Therefore, part of the first surface 16 of the first substrate 10D is exposed from the space between the common electrodes 30D adjacent to each other in the second direction Y. The part of the first surface 16 exposed from the space between the common electrodes 30D adjacent to each other in the second direction Y is hereinafter referred to as a linear first surface exposed portion 17A. The linear first surface exposed portion 17A extends in the first direction X and overlaps the first boundary line M1 in plan view. The linear first surface exposed portion 17A is provided with the insulating bank 180.

The common electrode 30D has a plurality of openings 35. The opening 35 is formed at the center of the individual detection region 5. The detection electrode 20D is disposed at the center of the opening 35. Therefore, the detection electrode 20D is surrounded by the common electrode 30D. The opening 35 is larger than the detection electrode 20D. Therefore, the detection electrode 20D and the common electrode 30D are separated from each other and are not electrically coupled on the first surface 16. Part of the first surface 16 is exposed from the space between the edge of the opening 35 of the common electrode 30D and the edge of the detection electrode 20. The part of the first surface 16 exposed through the opening 35 is hereinafter referred to as an annular (frame-shaped) first surface exposed portion 17B. The annular first surface exposed portion 17B has an annular shape (rectangular frame shape).

The spacer 160 has an insulating property and is made of the same organic material as the third insulating layer 15. As illustrated in FIG. 13, the spacer 160 is stacked across the first surface 16 and the first common electrode layer 31 as in the first embodiment. As a result, part of the second common electrode layer 32 serves as a protrusion 170 protruding in the first stacking direction Z1 with respect to the second detection electrode layer 22 (detection electrode 20D).

As illustrated in FIG. 14, the spacers 160 include a first side spacer 161 and a second side spacer 162 with the detection electrode 20D interposed therebetween, the first side spacer 161 is disposed on a first side of the detection electrode 20D in the second direction Y, and the second side spacer 162 is disposed on a second side of the detection electrode 20D in the second direction Y. The first side spacer 161 includes a pair of a fifth spacer 165 and a sixth spacer 166 spaced apart from each other in the second direction Y. The second side spacer 162 includes a pair of a seventh spacer 167 and an eighth spacer 168 spaced apart from each other in the second direction Y. The fifth spacer 165, the sixth spacer 166, the seventh spacer 167, and the eighth spacer 168 each extend in the first direction X.

Therefore, the protrusions 170 according to the second embodiment include a fifth protrusion 175 formed by the fifth spacer 165, a sixth protrusion 176 formed by the sixth spacer 166, a seventh protrusion 177 formed by the seventh spacer 167, and an eighth protrusion 178 formed by the eighth spacer 168.

The fifth protrusion 175, the sixth protrusion 176, the seventh protrusion 177, and the eighth protrusion 178 support the sensor layer 80 from a side of the sensor layer 80 in the second stacking direction Z2. Therefore, the gap S is formed between the sensor layer 80 and the detection electrode 20D as illustrated in FIG. 13. When the application of the force is released, the sensor layer 80 according to the second embodiment quickly moves away from the detection electrode 20D as in the first embodiment. In other words, the detection electrode 20D detects quickly (early) that no force is applied.

The conductive tape 91D is interposed between the sensor layer 80 and the protrusions 170 (the fifth protrusion 175, the sixth protrusion 176, the seventh protrusion 177, and the eighth protrusion 178). The sensor layer 80 is bonded to the protrusions 170 such that tension in the second direction Y acts on each individual detection region 5. Therefore, when the application of the force is released, the sensor layer 80 moves away from the detection electrode 20D more quickly. In other words, the detection electrode 20D detects more quickly (earlier) that no force is applied.

As illustrated in FIG. 14, the contact holes 6 include the first contact holes 7 covered by the detection electrode 20D and the second contact holes 8 covered by the common electrode 30D. The first contact hole 7 is formed at the center of the individual detection region 5. The second contact holes 8 include a plurality of first side second contact holes 8C and a plurality of second side second contact holes 8D. The first side second contact holes 8C are formed on the first side in the second direction Y with respect to the first contact holes 7 and the second side second contact holes 8D are formed on the second side in the second direction Y with respect to the first contact holes 7. The first side second contact holes 8C are equally spaced in the first direction X. Similarly, the second side second contact holes 8D are equally spaced in the first direction X. The insulating bank 180 will be described later.

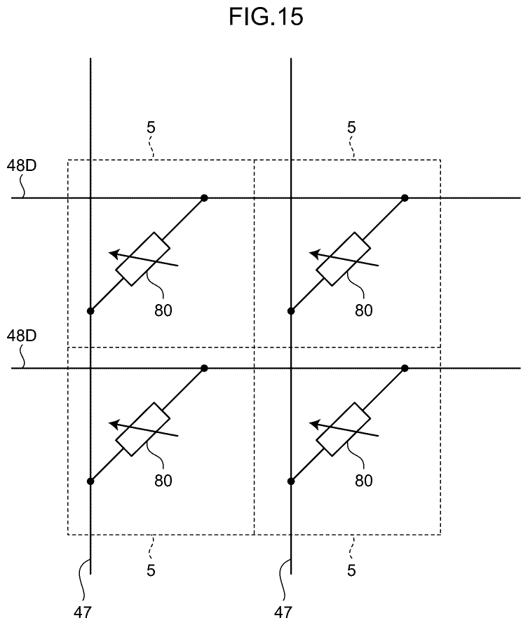

FIG. 15 is a circuit diagram of a circuit configuration of the detection device according to the second embodiment. As illustrated in FIG. 15, the first substrate 10D is provided with the signal lines 47 and reference potential lines 48D. In other words, the first substrate 10D according to the second embodiment is not provided with the transistor 40 or the gate line 46. Each of the reference potential lines 48D extends in the first direction X. The reference potential lines 48D are arrayed in the second direction Y.

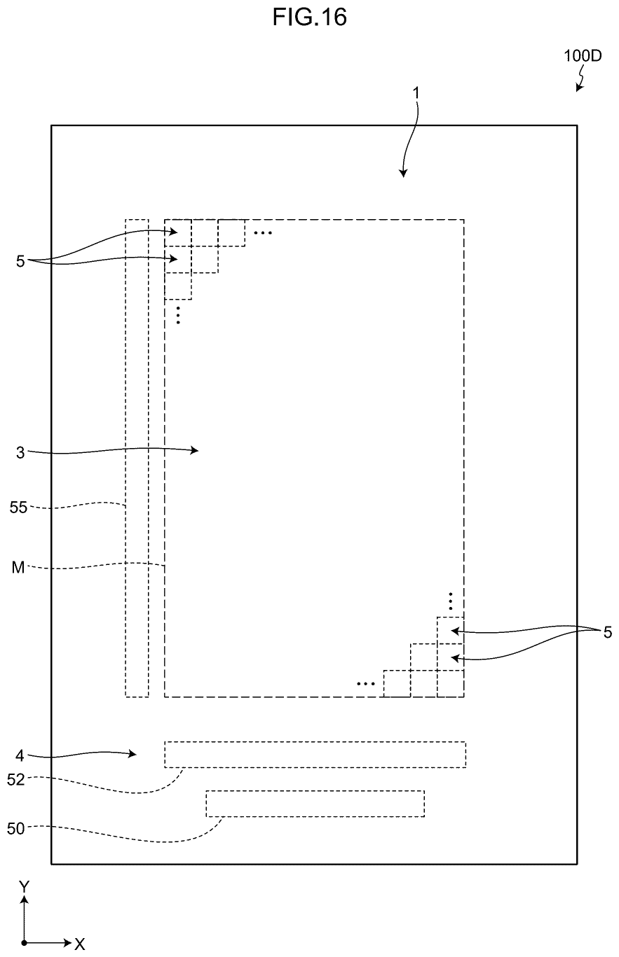

FIG. 16 is a schematic front view of the detection device according to the second embodiment. As illustrated in FIG. 16, the detection device 100D according to the second embodiment does not include the gate line drive circuit 51 because the detection device does not include the gate line 46. Instead of the gate line drive circuit 51, the detection device 100D according to the second embodiment includes a reference potential line selection circuit 55 that selects the reference potential line 48D to be driven out of the reference potential lines 48D. The reference potential line 48D is supplied with a predetermined amount of current from the reference potential line selection circuit 55. Therefore, the detection device 100D according to the second embodiment does not include the common line 53.

As illustrated in FIG. 14, the reference potential line 48D includes a reference potential main line 140, a reference potential parallel line 141, and a reference potential coupling line 142. The reference potential main line 140 extends in the first direction X. The reference potential parallel line 141 is parallel to the reference potential main line 140 with the detection electrode 20D interposed therebetween. The reference potential coupling line 142 extends in the second direction Y and couples the reference potential main line 140 and the reference potential parallel line 141.

The reference potential main line 140 extends across more than one of the individual detection regions 5. The reference potential main line 140 is disposed on the second side of the detection electrode 20D in the second direction Y. Therefore, the second side spacer 162 is disposed on the side where the reference potential main line 140 is disposed when viewed from the detection electrode 20D. The reference potential main line 140 overlaps more than one of the second side second contact holes 8D. The reference potential main line 140 is electrically coupled to the common electrode 30D through the second side second contact holes 8D.

Each reference potential coupling line 142 branches off from the reference potential main line 140 and extends along the second boundary line M2. The reference potential parallel line 141 is disposed on the first side of the detection electrode 20D in the second direction Y. Therefore, the first side spacer 161 is disposed on the side where the reference potential parallel line 141 is disposed when viewed from the detection electrode 20D. The reference potential parallel line 141 extends intermittently in the first direction X. Therefore, the reference potential parallel line 141 is composed of a plurality of partial potential lines 141A divided in the first direction X. The partial potential line 141A is coupled to the reference potential coupling line 142. The partial potential line 141A overlaps more than one of first side second contact holes 8C. Therefore, the partial potential line 141A is electrically coupled to the common electrode 30D through the first side second contact holes 8C. With this configuration, the currents flowing to respective parts of the common electrode 30D are uniform.

Part of the fifth spacer 165 and part of the sixth spacer 166 respectively overlap opposite ends of the reference potential parallel line 141 (partial potential line 141A) in the second direction Y. The seventh spacer 167 and the eighth spacer 168 respectively overlap opposite ends of the reference potential main line 140 in the second direction Y.

The detection method by the detection device according to the second embodiment is as follows: the reference potential line selection circuit 55 (refer to FIG. 16) selects one reference potential line 48 from the reference potential lines 48. Then, a predetermined amount of current is supplied to one common electrode 30D via the selected reference potential line 48. As a result, the force applied to the individual detection regions 5 arrayed in the first direction X can be detected. Next, the signal line selection circuit 52 sequentially selects the signal lines 47 arrayed in the first direction X and detects the amount of current flowing to the detection electrode 20D. After selecting all the signal lines 47, the reference potential line selection circuit 55 selects another reference potential line 48. In other words, the individual detection regions 5 arrayed in the first direction X are handled as one detection group according to the present embodiment. When detection on one detection group is completed, the detection target is shifted in the second direction Y.

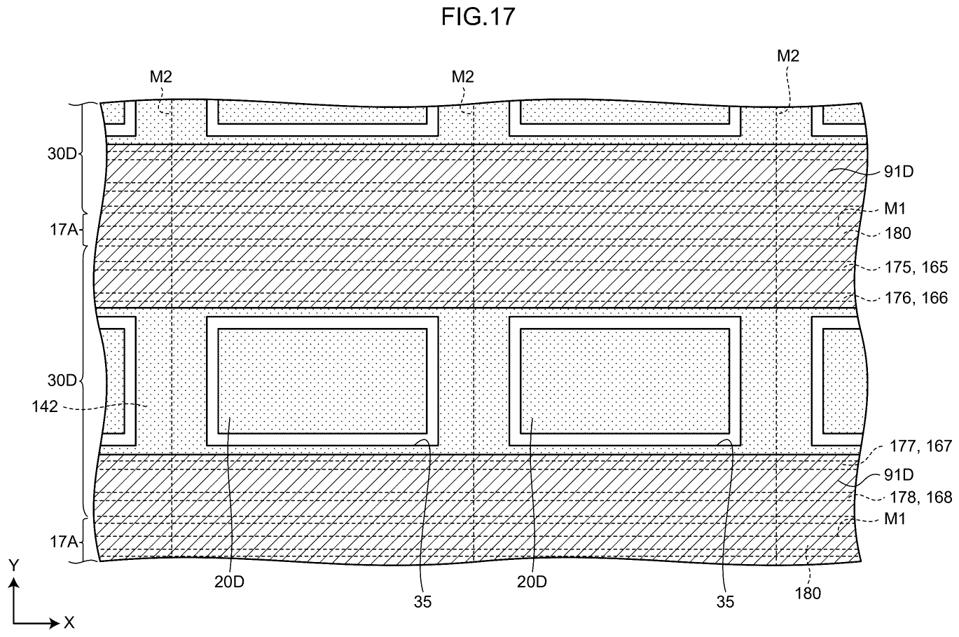

FIG. 17 is a view of a state where the conductive tapes are disposed on the first surface of the detection device according to the second embodiment viewed from the sensor layer. A conductive tape 91D according to the second embodiment extends in the first direction X. The conductive tape 91D overlaps the insulating bank 180 (first boundary line M1) in plan view. The conductive tape 91D also overlaps the seventh protrusion 177, the eighth protrusion 178, the fifth protrusion 175, and the sixth protrusion 176 in plan view. The seventh protrusion 177 and the eighth protrusion 178 are disposed on the first side of the insulating bank 180 in the second direction Y, and the fifth protrusion 175 and the sixth protrusion 176 are disposed on the second side of the insulating bank 180 in the second direction Y. Therefore, one conductive tape 91D bonds the insulating bank 180, the fifth protrusion 175, the sixth protrusion 176, the seventh protrusion 177, and the eighth protrusion 178 to the sensor layer 80.

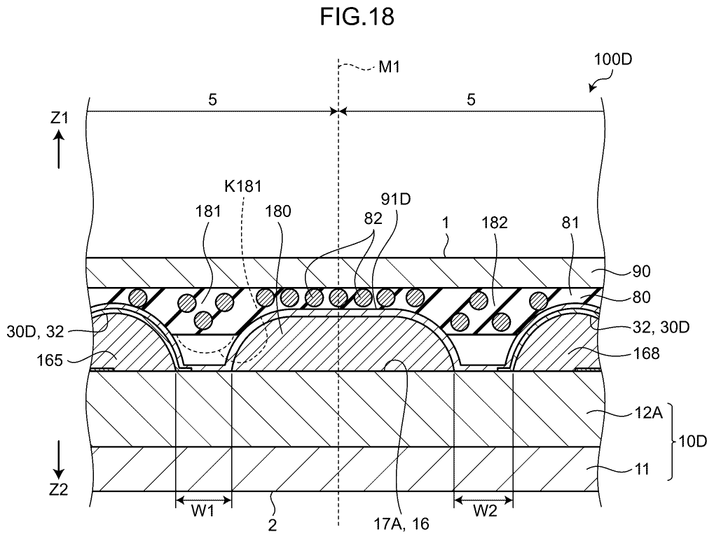

FIG. 18 is a schematic of a section along line XVIII-XVIII of FIG. 14. As illustrated in FIG. 18, the fifth spacer 165 and the eighth spacer 168 are disposed on opposite sides of the insulating bank 180 in the second direction Y. The insulating bank 180 protrudes in the first stacking direction Z1 and supports the sensor layer 80 through the conductive tape 91D. The insulating bank 180 has an insulating property and is made of the same organic material as the third insulating layer 15 and the spacer 160. The insulating bank 180 according to the present disclosure simply needs to have an insulating property and is not necessarily made of organic material. The insulating bank 180 extends in the first direction X along the linear first surface exposed portion 17A (refer to FIG. 14). The insulating bank 180 overlaps the first boundary line M1. In other words, the insulating bank 180 is disposed between the common electrodes 30D adjacent to each other in the second direction Y.

The distance between the insulating bank 180 and the fifth spacer 165 in the second direction Y is W1. The distance between the insulating bank 180 and the eighth spacer 168 in the second direction Y is W2. The part of the sensor layer 80 positioned between the insulating bank 180 and the fifth spacer 165 is hereinafter referred to as a first non-contact portion 181. The part of the sensor layer 80 positioned between the insulating bank 180 and the eighth spacer 168 is referred to as a second non-contact portion 182.

If the distance W1 between the insulating bank 180 and the fifth spacer 165 is small, the length (length in the second direction Y) of the first non-contact portion 181 is also small. Therefore, when force is applied, the amount of deformation in the second stacking direction Z2 is also small. The distance W1 according to the present embodiment is such a length that the first non-contact portion 181 is not deformed if force is applied to the first non-contact portion 181. In other words, the distance W1 is such a length that the first non-contact portion 181 does not come into contact with the first surface 16 (conductive tape 91D) if it is deformed in the second stacking direction Z2 by the force.

Similarly, the distance W2 between the insulating bank 180 and the eighth spacer 168 in the second direction Y is such a length that the second non-contact portion 182 does not come into contact with the first surface 16 (conductive tape 91D) if force is applied to the second non-contact portion 182 and the second non-contact portion 182 is deformed in the second stacking direction Z2.

As described above, the first non-contact portion 181 according to the second embodiment does not come into contact with the first surface 16 (conductive tape 91D) if force is applied to the first non-contact portion 181 (refer to an imaginary line K181 in FIG. 18). Therefore, the first non-contact portion 181 does not receive reaction force (refer to F2 in FIG. 6) from the first surface 16 and is not deformed. In other words, the resistance of the first non-contact portion 181 does not decrease, and no current passes through the first non-contact portion 181. Similarly, if force is applied to the second non-contact portion 182, the resistance of the second non-contact portion 182 does not decrease, and no current passes through the second non-contact portion 182. Therefore, when a predetermined amount of current is supplied to the common electrode 30D selected by the reference potential line selection circuit 55, the second embodiment prevents a current from flowing over the insulating bank 180 to other common electrodes 30D adjacent to the selected one in the second direction Y (crosstalk).

While the second embodiment has been described above, the present disclosure is not limited thereto. The conductive tape 91D according to the present disclosure may be an anisotropic conductive tape in which a current flows only in the thickness direction (stacking direction). The use of the anisotropic conductive tape can more reliably prevent a current from flowing over the insulating bank 180 to other common electrodes 30D adjacent in the second direction Y (crosstalk).

What is claimed is:

1. A detection device comprising:
a first substrate having a first surface formed of an organic insulating layer; and
a sensor layer facing the first surface, wherein
the first substrate is provided with:
a detection electrode provided on the first surface;
a common electrode provided on the first surface and disposed around the detection electrode;
a transistor covered by the organic insulating layer;
a gate line covered by the organic insulating layer and coupled to a gate electrode of the transistor;
a signal line covered by the organic insulating layer and coupled to one of a source electrode and a drain electrode of the transistor;
a reference potential line covered by the organic insulating layer;
a first contact hole formed on the first surface and coupling the other of the source electrode and the drain electrode of the transistor to the detection electrode;
a second contact hole formed on the first surface and coupling the reference potential line to the common electrode; and
a spacer that is provided between the first surface and the common electrode and makes part of the common electrode protrude toward the sensor layer with respect to the detection electrode, and
the sensor layer is supported by the common electrode with a gap between the sensor layer and the detection electrode.

2. The detection device according to claim 1, wherein the gap is an air gap.

3. The detection device according to claim 1, wherein the gap is filled with liquid.

4. The detection device according to claim 1, wherein the detection electrode and the common electrode each have a two-layered structure composed of two metal layers.

5. The detection device according to claim 1, wherein a conductive tape that bonds the common electrode and the sensor layer is provided between the common electrode and the sensor layer.

6. The detection device according to claim 1, wherein the first substrate comprises a flexible substrate as a base.

7. The detection device according to claim 1, wherein the spacer is made of organic material.

8. The detection device according to claim 1, wherein the spacer overlaps the reference potential line when viewed in a stacking direction in which the first substrate and the sensor layer are stacked.

9. The detection device according to claim 1, wherein
the first substrate is provided with a plurality of the detection electrodes, a plurality of the transistors, a plurality of the gate lines, a plurality of the signal lines, and a plurality of the reference potential lines,
the detection electrodes are arrayed in a first direction parallel to the first surface and a second direction parallel to the first surface and intersecting the first direction,
the transistors are arrayed in the first direction and the second direction corresponding to the respective detection electrodes,
the gate lines extend in the first direction and are arrayed in the second direction,
the signal lines extend in the second direction and are arrayed in the first direction, and
the reference potential lines extend in the second direction and are arrayed in the first direction.

10. The detection device according to claim 9, wherein
the spacer comprises a pair of a first spacer and a second spacer extending in the second direction and spaced apart from each other in the first direction,
when viewed in a stacking direction in which the first substrate and the sensor layer are stacked,
the first spacer overlaps a first end of the reference potential line in the first direction, and
the second spacer overlaps a second end of the reference potential line in the first direction.

11. The detection device according to claim 10, wherein
the reference potential line is provided with a reference potential branch line branching off in the first direction,
the spacer comprises a pair of a third spacer and a fourth spacer extending in the first direction and spaced apart from each other in the second direction,
the third spacer and the fourth spacer each intermittently extending in the first direction,
the third spacer overlaps at least partially with a first end of the reference potential branch line in the second direction, and
the fourth spacer overlaps at least partially with a second end of the reference potential branch line in the second direction.

12. The detection device according to claim 1, wherein the detection electrode is surrounded by the common electrode.

13. A detection device comprising:
a first substrate having a first surface formed of an organic insulating layer; and
a sensor layer facing the first surface, wherein
the first substrate is provided with:
a detection electrode provided on the first surface;
a common electrode disposed around the detection electrode on the first surface;
a signal line covered by the organic insulating layer;
a reference potential line covered by the organic insulating layer;
a first contact hole formed on the first surface and coupling the signal line to the detection electrode;
a second contact hole formed on the first surface and coupling the reference potential line to the common electrode; and
a spacer provided between the first surface and the common electrode and that makes part of the common electrode protrude toward the sensor layer with respect to the detection electrode, and
the sensor layer is supported by the common electrode with a gap between the sensor layer and the detection electrode.

14. The detection device according to claim 13, wherein
the first substrate is provided with a plurality of the detection electrodes, a plurality of the signal lines, and a plurality of the reference potential lines,
the detection electrodes are arrayed in a first direction parallel to the first surface and a second direction parallel to the first surface and intersecting the first direction,
the signal lines extend in the second direction and are arrayed in the first direction, and
the reference potential lines extend in the first direction and are arrayed in the second direction.

15. The detection device according to claim 14, wherein
the reference potential line comprises:
a reference potential main line extending in the first direction;
a reference potential parallel line extending intermittently in the first direction and disposed opposite to the reference potential main line with the detection electrode interposed between the reference potential parallel line and the reference potential main line; and
a plurality of reference potential coupling lines extending in the second direction and coupling the reference potential main line and the reference potential parallel line,
the spacer comprises a first side spacer and a second side spacer disposed on opposite sides of the detection electrode,
the first side spacer is disposed on a side where the reference potential parallel line is disposed when viewed from the detection electrode,
the second side spacer is disposed on a side where the reference potential main line is disposed when viewed from the detection electrode,
the first side spacer comprises a pair of a fifth spacer and a sixth spacer extending in the first direction and spaced apart from each other in the second direction,
the second side spacer comprises a pair of a seventh spacer and an eighth spacer extending in the first direction and spaced apart from each other in the second direction,
when viewed in a stacking direction in which the first substrate and the sensor layer are stacked,
the fifth spacer overlaps a first end of the reference potential line in the second direction,
the sixth spacer overlaps a second end of the reference potential line in the second direction,
the seventh spacer overlaps at least partially with a first end of the reference potential main line in the second direction, and
the eighth spacer overlaps at least partially with a second end of the reference potential main line in the second direction.

16. The detection device according to claim 15, wherein an insulating bank extending in the first direction is provided between the fifth spacer and the eighth spacer.

17. The detection device according to claim 13, wherein the spacer is made of organic material.

18. The detection device according to claim 13, wherein the detection electrode is surrounded by the common electrode.

19. The detection device according to claim 13, wherein a conductive tape that bonds the common electrode and the sensor layer is provided between the common electrode and the sensor layer.

20. The detection device according to claim 19, wherein the conductive tape is an anisotropic conductive tape that electrically couples the common electrode and the sensor layer.
